(19) United States
(12) Patent Application Publication
(10) Pub. No.: US 2026/0200096 A1
(43) Pub. Date: Jul. 16, 2026

(54) GRIPPER FOR GRASPING AN IRREGULAR OBJECT AND A ROBOTIC DEVICE INCLUDING THE SAME

(71) Applicant: SAMSUNG ELECTRONICS CO., LTD., Suwon-si (KR)

(72) Inventors: Myungki SEO, Suwon-si (KR); Eungpyo KIM, Suwon-si (KR)

(73) Assignee: SAMSUNG ELECTRONICS CO., LTD., Suwon-si (KR)

(21) Appl. No.: 19/553,802

(22) Filed: Mar. 2, 2026

Related U.S. Application Data
(63) Continuation of application No. PCT/KR2026/001025, filed on Jan. 16, 2026.

(30) Foreign Application Priority Data
Jan. 16, 2025 (KR) 10-2025-0006613

(51) Int. Cl. B25J 9/16; B25J 15/00; B25J 15/02; G06V 20/50

(52) U.S. Cl. CPC B25J 9/1697; B25J 15/0033; B25J 15/0253; G06V 20/50

(57) ABSTRACT

A robot apparatus including a gripper is disclosed. The disclosed gripper includes a first finger, a second finger facing the first finger, a driving motor configured to provide power to drive the first finger and the second finger closer to each other and to drive the first finger and the second finger away from each other, a first fingertip connected to the first finger, and a second fingertip connected to the second finger and facing the first fingertip. Each of the first fingertip and the second fingertip includes a body, a base plate coupled to the body, and a hook member on the base plate. The hook member is configured to protrude when pressed by an object while the first fingertip and the second fingertip grasp the object.

### CROSS REFERENCE TO RELATED APPLICATIONS

The present application is a by-pass continuation of International Application No. PCT/KR2026/001025, filed on January 16, 2026, which claims priority to Korean Patent Application No. 10-2025-0006613, filed on January 16, 2025 in the Korean Intellectual Property Office, the contents of which are incorporated by reference herein in their entireties.

### BACKGROUND

### 1. Field

The disclosure relates to a gripper for grasping an irregular object and a robot apparatus including the same.

### 2. Description of the Related Art

With developments in technology, robot technology is being utilized to substitute human labor in various fields. Specifically, robot apparatuses are being developed in fields that require detailed and elaborate work such as factories, construction, medical field, and space aeronautics. However, robot apparatuses of the related art have been limited in stably grasping irregular food products.

### SUMMARY

According to an aspect of the disclosure, a gripper includes: a first finger; a second finger facing the first finger; a driving motor configured to provide power to drive the first finger and the second finger closer to each other and to drive the first finger and the second finger away from each other; a first fingertip connected to the first finger; and a second fingertip connected to the second finger and facing the first fingertip, wherein each of the first fingertip and the second fingertip includes: a body; a base plate coupled to the body; and a hook member on the base plate, and wherein the hook member is configured to protrude when pressed by an object while the first fingertip and the second fingertip grasp the object.

For each of the first fingertip and the second fingertip, the hook member may include: a cushion protrusion coupled to one surface of the base plate, the cushion protrusion including a cavity; and a hook connected to the cushion protrusion, wherein the hook is configured to rotate in a first direction when a pressing force is applied to the cushion protrusion and rotate in a second direction which is opposite of the first direction when a pressing force is released from the cushion protrusion.

For each of the first fingertip and the second fingertip, the hook may include: a first portion positioned at the cavity of the cushion protrusion; a second portion connected to the first portion, wherein the second portion is outside of the cushion protrusion and is bent at an angle with respect to the first portion; and a third portion positioned at a boundary of the first portion and the second portion, wherein the third portion is connected to the cushion protrusion, and wherein, for each of the first fingertip and the second fingertip, the hook is configured to rotate in the first direction or the second direction using the third portion as a rotational center.

For each of the first fingertip and the second fingertip: the first portion is configured to move toward the base plate based on application of a pressing force to the cushion protrusion, and the second portion is configured to move away from the base plate and support an object grasped by the first fingertip and the second fingertip based on rotation of the first portion.

For each of the first fingertip and the second fingertip, the second portion is configured to be moved to a first position at which a lower end of the second portion and the base plate are spaced apart by a first distance, and to be moved to a second position at which the lower end of the second portion and the base plate are spaced apart by a second distance that is greater than the first distance.

For each of the first fingertip and the second fingertip, the second portion may be parallel to the base plate at the first position.

The first distance may be smaller than a thickness of the cushion protrusion.

For each of the first fingertip and the second fingertip, the second portion of the hook is concavely formed toward the base plate and is configured to be inserted in a groove on the base plate.

For each of the first fingertip and the second fingertip, the cushion protrusion may include silicon or rubber.

Each of the first fingertip and the second fingertip, the hook may include stainless steel or synthetic resin.

For each of the first fingertip and the second fingertip, the second portion may include a coating layer having a friction coefficient greater than a friction coefficient of the hook at a side surface that is contacted with the object.

The first fingertip may be connected to the first finger through a first supporter, and the second fingertip may be connected to the second finger through a second supporter.

The first fingertip may be elastically connected to the first supporter, and the second fingertip may be elastically connected to the second supporter.

The first finger and the second finger may include a magnetic material, wherein the first fingertip may include a first permanent magnet, the first permanent magnet detachably attaches the first fingertip to the first finger, the second fingertip may include a second permanent magnet, and the second permanent magnet detachably attaches the second fingertip to the second finger.

According to an aspect of the disclosure, a robot apparatus includes: a robot arm including a plurality of joints; a gripper connected to an end portion of the robot arm, the gripper including a first finger coupled with a first fingertip and a second finger coupled with a second fingertip; a driving motor configured to provide power to the gripper to move the first finger and the second finger away from each other and closer to each other; an image sensor configured to obtain an image of a target contained in a container; memory storing at least one instruction; and at least one processor configured to individually or collectively execute the at least one instruction, wherein the at least one instruction, when executed by the at least one processor individually or collectively, causes the robot apparatus to: identify the target based on the image, and control the driving motor to move the first finger and the second finger together to grasp the target through the first fingertip and the second fingertip, wherein each of the first fingertip and the second fingertip may include: a body; a base plate coupled to the body; and a hook member on the base plate, wherein the hook member is configured to protrude when pressed by the target while the first fingertip and the second fingertip grasp the target, and wherein for each of the first fingertip and the second fingertip, the hook member may include: a cushion protrusion coupled to one surface of the base plate, the cushion protrusion including a cavity; and a hook connected to the cushion protrusion, wherein the hook is configured to rotate in a first direction when a pressing force is applied to the cushion protrusion and rotate in a second direction which is opposite of the first direction when a pressing force is released from the cushion protrusion.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram illustrating a robot apparatus according to one or more embodiments of the disclosure;

FIG. 2 is a side view illustrating a robot apparatus according to one or more embodiments of the disclosure;

FIG. 3 is a plane view illustrating a robot apparatus according to one or more embodiments of the disclosure;

FIG. 4 is a diagram illustrating a gripper according to one or more embodiments of the disclosure;

FIG. 5 is a perspective view illustrating a fingertip of a gripper according to one or more embodiments of the disclosure;

FIG. 6 is a front view illustrating a fingertip of a gripper according to one or more embodiments of the disclosure;

FIG. 7 is a cross-sectional view taken along line A-A’ shown in FIG. 6;

FIG. 8 is a perspective view illustrating a fingertip of a gripper according to one or more embodiments of the disclosure;

FIG. 9 is a front view illustrating a fingertip of a gripper according to one or more embodiments of the disclosure;

FIG. 10 is a cross-sectional view taken along line B-B’ shown in FIG. 9;

FIG. 11 is a diagram illustrating an example of a gripper grasping an irregular food product according to one or more embodiments of the disclosure;

FIG. 12 is an enlarged cross-sectional view illustrating a hook member according to one or more embodiments of the disclosure;

FIG. 13 is an enlarged cross-sectional view illustrating a hook member according to one or more embodiments of the disclosure; and

FIG. 14 is an enlarged cross-sectional view illustrating an operating state of the hook member shown in FIG. 13.

With respect to the description of the foregoing drawings, same or like reference numerals may be used for same or like elements.

### DETAILED DESCRIPTION

Various modifications may be made to embodiments of the disclosure, and there may be various types of embodiments. Accordingly, specific embodiments will be illustrated in drawings, and described in detail in the detailed description. However, it should be noted that the one or more embodiments described herein are not intended to limit the scope of the disclosure to a specific embodiment, but said embodiments should be interpreted to include all modifications, equivalents or alternatives of one or more embodiments included in the ideas and the technical scopes disclosed herein.

In describing the disclosure, in situations where the detailed description of related known technologies or configurations may unnecessarily confuse the gist of the disclosure, the detailed description thereof will be omitted. Further, one or more embodiments according to the disclosure may be modified to various different forms, and it is to be understood that the scope of the technical spirit of the disclosure is not limited to the one or more embodiments described below. Rather, the one or more embodiments are provided so that the disclosure will be thorough and complete, and to fully convey the technical spirit of the disclosure to those skilled in the art.

Terms used in the disclosure have been merely used to describe one or more specific embodiments, and such terms are not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first”, or “second” used in the disclosure may limit various elements regardless of order and/or importance, and may be used merely to distinguish one element from another element and not limit the relevant element.

The expression “configured to… (or set up to)” used in the disclosure may be used interchangeably with, for example, “suitable for…”, “having the capacity to…”, “designed to…”, “adapted to…”, “made to…”, or “capable of…” based on circumstance. The term “configured to… (or set up to)” may not necessarily mean “specifically designed to” in terms of hardware.

In the disclosure, the term “module” or “part” perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

Various elements and areas of the drawings have been schematically illustrated. Accordingly, the technical spirit of the disclosure is not limited by relative sizes and distances illustrated in the accompanied drawings.

One or more embodiments according to the disclosure will be described in detail below with reference to the accompanied drawings to aid in the understanding of those of ordinary skill in the art.

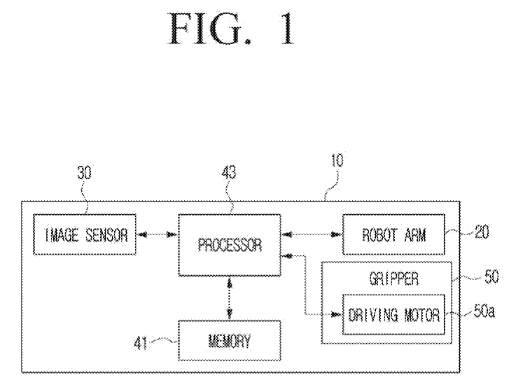

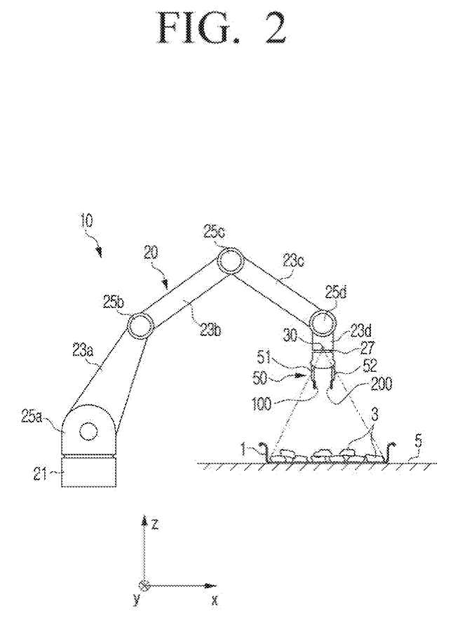

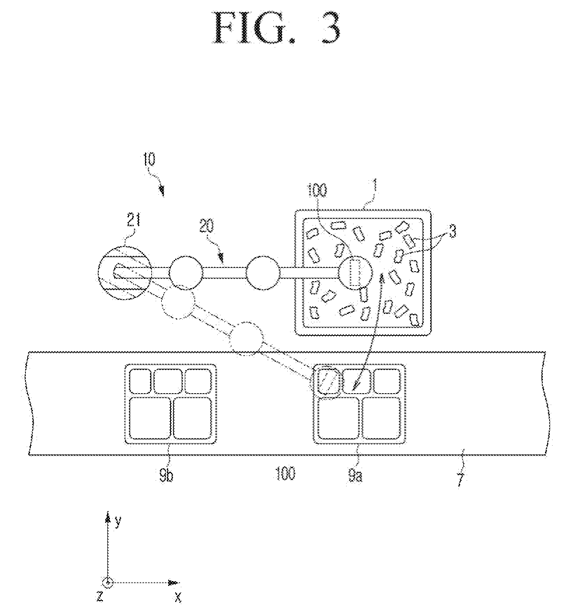

FIG. 1 is a block diagram illustrating a robot apparatus 10 according to one or more embodiments of the disclosure, FIG. 2 is a side view illustrating a robot apparatus according to one or more embodiments of the disclosure, and FIG. 3 is a plane view illustrating a robot apparatus according to one or more embodiments of the disclosure.

Referring to FIG. 1, FIG. 2, and FIG. 3, the robot apparatus 10 according to one or more embodiments may include a robot arm 20, and an image sensor 30, a gripper 50, a memory 41, and a processor 43.

According to one or more embodiments, the robot arm 20 may be configured to be multi-axis drivable so as to transport a side dish (e.g., one piece selected from among a plurality of side dish pieces 3 constituting a side dish (banchan)) contained in a side dish container 1 to target containers 9a and 9b (e.g., a food tray or a lunch box container for sale). However, the disclosure is not limited to transport of side dishes, and may apply to other types of objects. For example, a multi-axis driving may include a 3-axis linear movement (e.g., X-axis linear movement, Y-axis linear movement, and Z-axis linear movement) and a 3-axis rotational movement (roll, pitch, and yaw).

According to one or more embodiments, the robot arm 20 may include a base 21, a plurality of links, and a plurality of joints. The plurality of links may include a first link 23a, a second link 23b, a third link 23c, and a fourth link 23d. The plurality of links may include a first joint 25a which connects the base 21 and the first link 23a, a second joint 25b which connects the first link 23a and the second link 23b, a third joint 25c which connects the second link 23b and third link 23c, and a fourth joint 25d which connects the third link 23c and the fourth link 23d.

According to one or more embodiments, the first joint 25a may be connected to a rotational axis of the base 21 (e.g., an axis parallel to Z-axis of FIG. 2) and rotated in a clockwise direction or an anti-clockwise direction based on the rotational axis of the base 21. Inside of the base 21, the first joint 25a, the second joint 25b, the third joint 25c, the fourth joint 25d, and the fourth link 23d, a motor that is drivable in a forward rotation and a reverse rotation (e.g., step motor) may be disposed, respectively. The robot arm 20 shown in FIG. 2 and FIG. 3 has been described as including four links and four joints as an example, but the disclosure is not limited thereto. The robot arm 20 may include a number of links and joints with which operation of transferring the side dish pieces 3 contained in the side dish container 1 to the target containers 9a and 9b is possible. For example, the robot arm 20 may include at least three links, a base, and at least three joints for connecting between the three links.

According to one or more embodiments, the image sensor 30 may be disposed at the fourth link 23d. The image sensor 30 may be controlled by the processor 43 so as to obtain image information by capturing the plurality of side dish pieces 3 constituting the side dish contained in the side dish container 1. For example, the image information may include position coordinates, sizes, shapes, and the like of each of the plurality of side dish pieces 3.

According to one or more embodiments, the image sensor 30 may include a vision camera, an RGB camera (color camera), a depth camera, a stereo camera, a light detection and ranging (LiDAR), an infrared camera, and/or a time of flight (ToF) camera. For example, the image sensor 30 may include the vision camera which obtains a 2D image together with the depth camera or LiDAR for obtaining an accurate height information in case the plurality of side dish pieces 3 are stacked at the bottom of the side dish container 1.

According to one or more embodiments, the gripper 50 may be connected to a rotational part 27 that is disposed at a free end of the fourth link 23d. The rotational part 27 may include a step motor to forward rotate and reverse rotate the gripper 50 about a center axis of the fourth link 23d along a length direction (a direction parallel to Z-axis in FIG. 2) of the fourth link 23d.

According to one or more embodiments, the gripper 50 may include a first finger 51 and a second finger 52 disposed to face the first finger 51. The first finger 51 and the second finger 52 may be driven by a driving motor 50a of the gripper 50. For example, if the driving motor 50a of the gripper 50 rotates in a forward direction, the first finger 51 and the second finger 52 may be driven closer to each other. If the driving motor 50a of the gripper 50 rotates in a reverse direction, the first finger 51 and the second finger 52 may be driven away from each other.

According to one or more embodiments, the first finger 51 may include a first fingertip 100. The second finger 52 may include a second fingertip 200 that faces the first fingertip 100. The first fingertip 100 and the second fingertip 200 may increase frictional force at a portion that contacts with a food product (or other object) to minimize a food product 3 falling in the direction of gravity when grasping the food product 3. Accordingly, the gripper 50 according to one or more embodiments of the disclosure may stably grasp a regular or irregular food product (or other object) by the first fingertip 100 and the second fingertip 200. The first fingertip 100 and the second fingertip 200 may be formed of substantially the same configuration and will be described in detail below.

According to one or more embodiments, the gripper 50 may be controlled by the processor 43 to grasp a piece of side dish 3 contained in the side dish container 1, and drop the piece of side dish 3 at a determined position within a determined target container 9a or 9b after the position is moved to the determined target container 9a or 9b by the robot arm 20. For example, the side dish container 1 may be seated over a work table 5. The target containers 9a and 9b may be seated on a conveyor device 7 disposed at one side of the work table 5. The conveyor device 7 may be controlled by the processor 43 to move or stop the target containers 9a and 9b.

According to one or more embodiments, the memory 41 may be a configuration for including various programs, instructions, data, and the like necessary in an operation of the robot apparatus 10. The memory 41 may be stored with at least one instruction. The memory 41 in FIG. 1 has been shown as separate from the processor 43, but is not necessarily limited thereto, and the memory 41 may be implemented as an internal memory such as a read only memory (ROM) (e.g., an electrically erasable programmable read-only memory (EEPROM)), a random access memory (RAM), and the like included in the processor 43.

According to one or more embodiments, the memory 41 may be implemented in a form of a memory embedded in the robot apparatus 10 according to a data storage use, or in a form of a memory attachable to or detachable from the robot apparatus 10. For example, the memory 41 may be implemented in various forms such as, for example, and without limitation, a volatile memory (e.g., a static RAM (SRAM) or a synchronous dynamic RAM (SDRAM)), a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive, or a solid state drive (SSD)), a compact flash (CF), a secure digital (SD), a micro secure digital (MicroSD), a mini secure digital (Mini-SD), an extreme digital (xD), a multi-media card (MMC), or the like. In the case of the memory attachable to or detachable from the electronic apparatus 100, the memory may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, or the like.

In the disclosure, the term “memory 41” may include a storage part, the ROM, or the RAM in the processor 43, or a memory card mounted to the robot apparatus (e.g., a micro SD card, a memory stick). The memory 41 in FIG. 1 has been shown as one, but the memory 41 may be implemented in various numbers.

According to one or more embodiments, the memory 41 may store at least one instruction, an operating system (O/S), programs, data, and the like with respect to the robot apparatus 10. The memory 41 may be accessed by the processor 43. In the memory 41, reading/writing/modifying/deleting/updating and the like of data may be performed by the processor 43.

For example, the memory 41 may be stored with various information such as, for example, and without limitation, information about the image sensor 30, image information obtained by the image sensor 30, characteristic information of a side dish, information about the driving motor 50a of the gripper 50, distance information between the first fingertip 100 and the second fingertip 200 of the gripper 50, and the like, and programs, instructions, and the like for controlling operations of the robot apparatus 100 and other devices.

According to one or more embodiments, the memory 41 may store a plurality of pre-trained artificial intelligence models. For example, an artificial intelligence model may be implemented as a Convolutional Neural Network (CNN), a Long Short-Term Memory (LSTM), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), and the like, but is not limited to the above-described examples. The artificial intelligence model described above may be a computing system implemented by designing a neural network of a human or animal brain, and may be referred to as a training model, a machine learning model, a neural network model, a deep learning model, and the like.

According to one or more embodiments, the memory 41 may be stored with an artificial intelligence model trained to select a grasping distance that matches the characteristic information of the side dish (e.g., stiffness, density, texture, and the like of a material that constitutes the side dish). Here, the grasping distance may be a distance between the first fingertip 100 and the second fingertip 200.

According to one or more embodiments, the processor 43 may control the overall operation of the robot apparatus 10. For example, the processor 43 may be connected with configurations of an electronic apparatus that includes the memory 41, and by executing at least one instruction stored in the memory 41 as described above, control the operations of the electronic apparatus overall. Specifically, the processor 43 may be implemented with not only one processor, but also implemented with a plurality of processors.

According to one or more embodiments, the processor 43 may be implemented as one or more integrated circuit (or circuitry; IC) chips, and executed various data processing. The processor 43 may include at least one electric circuitry, and individually or collectively perform distributed processing of instructions (or programs, data, and the like) stored in the memory.

According to one or more embodiments, the processor 43 may include an assembly of processors that include one or more processing circuitry. The processor 43 may include any operative processing circuitry for controlling performances and operations of one or more elements (e.g., memory and/or driving devices (motor, sensor)) of the robot apparatus 10. For example, the processor 43 (e.g., AP) may be implemented as a system on chip (SoC) (e.g., one chip or a chipset). For example, the processor 43 may be implemented as a plurality of cores (or at least one core circuitry), a plurality of chips, or a plurality of chip sets.

For example, the processor 43 may include one or more processing circuitry. Further, the processor 43 may include one or more processing circuitry configured to individually and/or collectively perform several functions of the disclosure. As a unlimited example, at least a portion of the processor 43 may be included with a first chip of the robot apparatus 10, and at least another portion of the processor 43 may be included with a second chip of a robot apparatus different from the first chip of the robot apparatus 10.

For example, the processor 43 may include a central processing unit (CPU), a graphics processing unit (GPU), a neural processing unit (NPU), an image signal processor (ISP), a display controller, a memory controller, a storage controller, a communication processor (CP), and/or a sensor interface. The elements described of the processor 43 are merely examples. The processor 43 may further include other elements in addition to the above-described configuration. In addition, a few of the elements of the processor 43 may be omitted. Further, the few of the elements of the processor 43 may be included as separate elements of the robot apparatus 10 outside of the processor 43. For example, a portion of the elements (e.g., memory controller) of the processor 43 may be included in other elements (e.g., at least a portion of memory, interface (e.g., usable for connecting to at least one element of the robot apparatus 10), display).

According to one or more embodiments, the processor 43 may cause other elements of the robot apparatus 10 to perform various operations by executing the instructions stored in the memory 41. The processor 43 may process setting values, function commands, and the like according to control programs or control data stored in the memory 41, and output a control signal associated with a function performable by the robot apparatus 10 or a communication signal for communicating with an external robot apparatus.

According to one or more embodiments, the processor 43 may control, based on image information obtained by at least one image sensor 30, driving of the robot arm 20 to set a position of the gripper 50. For example, the image information may be image information including position coordinates, sizes, shapes, and the like of each of the plurality of side dish pieces 3 contained in the side dish container 1.

According to one or more embodiments, the processor 43 may control the gripper 50 to grasp one side dish piece from among the plurality of side dish pieces 3 contained in the side dish container 1, control the robot arm 20 to transport the side dish piece grasped by the gripper 50 over the target container 9a or 9b, and control the gripper 50 to drop the piece of side dish 3 at the target container 9a or 9b.

According to one or more embodiments, the processor 43 may identify a pattern of change of electric signals corresponding to a load of the driving motor 50a that drives the gripper 50 in a process of grasping the piece of side dish 3 with the gripper 50. The processor 43 may control, based on a reference signal pattern stored in the memory 41 and the identified pattern of change of electric signals not matching, the driving motor 50a to grasp the piece of side dish 3 again through the gripper 50. For example, the processor 43 may drive the first finger 51 and the second finger 52 in a direction moving away from each other by driving the driving motor 50a in the reverse direction. In addition, the processor 43 may move the gripper 50 to an initial position by driving the robot arm 20.

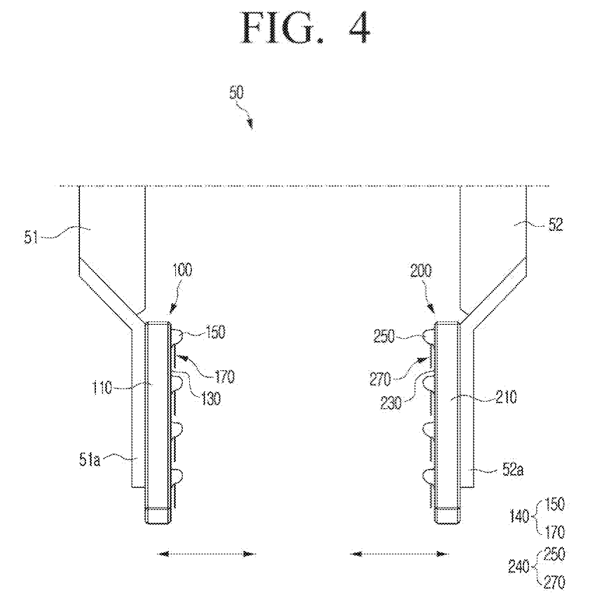

FIG. 4 is a diagram illustrating the gripper 50 according to one or more embodiments of the disclosure.

Referring to FIG. 4, the gripper 50 grasping an object according to one or more embodiments may grasp not only a regular object having a certain shape, but also an irregular object with an irregular shape. The regular object and the irregular object that can be grasped by the gripper 50 may be a food product (e.g., side dish).

According to one or more embodiments, the gripper 50 may include the first finger 51, the second finger 52, the first fingertip 100 coupled to the first finger 51, and the second fingertip 200 coupled to the second finger 52. For example, the first finger 51 and the second finger 52 may be driven by power provided from the driving motor 50a of the gripper 50. The gripper 50 may include a power transferring member that transfers power of the driving motor 50a to the first finger 51 and the second finger 52.

For example, the power transferring member may be a rack and pinion gear structure or a lead screw and nut structure. For example, if the power transferring member is a pinion gear structure, rotation of the driving motor 50a may be transferred to a first rack gear and a second rack gear that are disposed symmetrically with respect to the pinion gear and gear connected to each pinion gear. In this case, the first rack gear and the second rack gear may be moved in a direction that becomes close to each other when the pinion gear rotates in the forward direction, and moved in a direction that moves away from each other when rotated in the reverse direction. For example, if the power transferring member is the lead screw and nut structure, a first nut and a second nut which are connected to a screw may move in opposite directions from each other when the driving motor 50a rotates the screw. The first nut may be connected to the first finger 51 and the second nut may be connected to the second finger 52. Accordingly, the first finger 51 and the second finger 52 may be moved in a direction becoming closer to each other when the screw is forward rotated, and moved in a direction moving away from each other when reverse rotated.

The power transferring member included in the gripper 50 according to one or more embodiments is not limited to the rack and pinion gear structure and the lead screw and nut structure. For example, the power transferring member may be any structure so long as it is a structure that can drive the first finger 51 and the second finger 52 simultaneously in the direction that becomes close to each other and in the direction that moves away from each other according to the forward rotation and reverse rotation of the driving motor 50a.

According to one or more embodiments, a first supporter 51a may be coupled at an outer side surface of the first finger 51 (e.g., an opposite surface of a surface facing a side of the second finger 52). The first supporter 51a may protrude a determined length from an end portion of the first finger 51. The first fingertip 100 may be connected at an inner side surface of the first supporter 51a (e.g., the surface facing the side of the second finger 52). The second finger 52 may be substantially disposed symmetrically to the first finger 51. A second supporter 52a may be coupled at an outer side surface of the second finger 52 (e.g., an opposite surface of a surface facing a side of the first finger 51). The second supporter 52a may protrude a determined length from an end portion of the second finger 52. The second fingertip 200 may be connected at an inner side surface of the second supporter 52a (e.g., the surface facing the side of the first finger 51).

According to one or more embodiments, the first fingertip 100 may be fixed by connector (e.g., screws, adhesive, etc.) to the first supporter 51a, but the disclosure is not limited thereto. For example, the first fingertip 100 may be detachably attached to the first supporter 51a using a magnetic method. In this case, the first supporter 51a may be formed of a magnetic material, and a permanent magnet may be included in the first fingertip 100. The second fingertip 200 may also be detachably attached to the second supporter 52a using the magnetic method. Accordingly, when the first and second fingertips 100 and 200 are damaged or malfunction, the first and second fingertips 100 and 200 can be replaced with new fingertips, thereby facilitating maintenances.

According to one or more embodiments, the first fingertip 100 and the second fingertip 200 may be disposed to be symmetrical to each other. A food product 3 grasped by the gripper 50 may be positioned between the first fingertip 100 and the second fingertip 200. The first supporter 51a and the second supporter 52a may be formed of a metal material having elasticity. Accordingly, when the food product 3 is grasped between the first fingertip 100 and the second fingertip 200, the first fingertip 100 may be elastically supported by the first supporter 51a and the second fingertip 200 may be elastically supported by the second supporter 52a. Accordingly, the gripper 50 may stably grasp the food product 3 without applying excessive pressure (e.g., pressure of an extent of damaging the surface of the food product 3) to the irregularly shaped and/or low hardness food product 3.

According to one or more embodiments, the first fingertip 100 and the second fingertip 200 may include a plurality of hook members 140 and 240, respectively, at side surfaces that face each other. Because the first fingertip 100 and the second fingertip 200 can include substantially the same configuration, the configuration of the first fingertip 100 will be described in detail below.

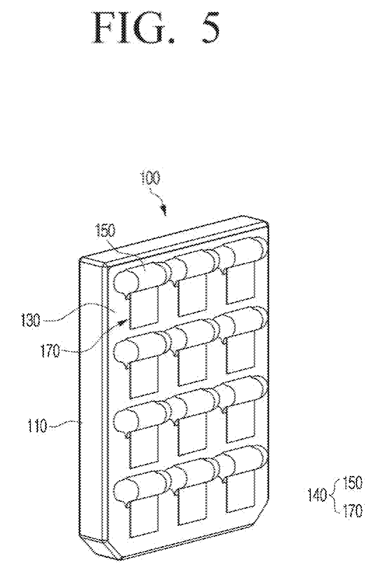

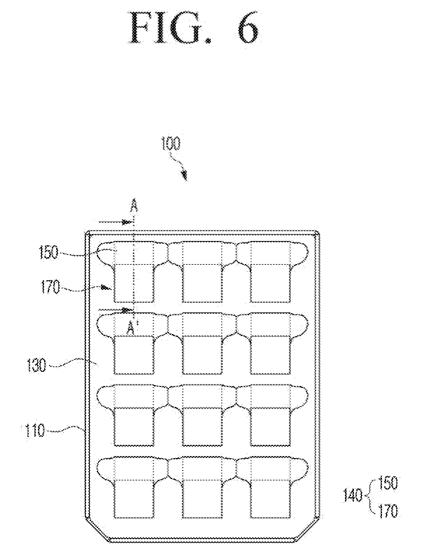

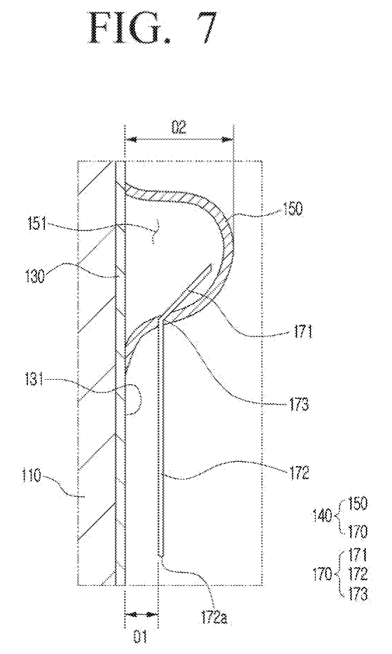

FIG. 5 is a perspective view illustrating the fingertip 100 of the gripper 50 according to one or more embodiments of the disclosure. FIG. 6 is a front view illustrating the first fingertip 100 of the gripper 50 according to one or more embodiments of the disclosure. FIG. 7 is a cross-sectional view taken along line A-A’ shown in FIG. 6.

Referring to FIG. 5 and FIG. 6, the first fingertip 100 according to one or more embodiments may include a body 110 coupled to the first supporter 51a (referring to FIG. 4), a base plate 130 mounted to one surface of the body 110, and a plurality of hook members 140 that is arranged. For example, the plurality of hook members 140 may be arranged in n rows × m columns (e.g., 4 rows × 3 columns as shown in FIG. 6) on the base plate 130. Similarly, the second fingertip 200 may include a body 210 coupled to second supporter 52a, a base plate 230 mounted to one surface of the body 210, and a plurality of hook members 240, where the plurality of hook members 240 are similarly arranged to the plurality of hook members 140. The plurality of hook members 140 may be arranged in a grid form as in FIG. 6, but the disclosure is not limited thereto, and the hook members 140 may be arranged in an unspecified manner.

According to one or more embodiments, each of the plurality of hook members 140 may include substantially the same configuration. For example, each hook member 140 may include a cushion protrusion 150 fixed at the base plate 130, and a hook 170 that is hingeably connected by the cushion protrusion 150.

In an alternative embodiment, the second fingertip 200 may only include a body 210 coupled to second supporter 52a, and the second fingertip 200 may not include a plurality of hook members 240.

Referring to FIG. 7, the cushion protrusion 150 may be coupled at one surface 131 of the base plate 130. The cushion protrusion 150 may include a material having flexibility and elasticity (e.g., silicon, rubber). The cushion protrusion 150 may be provided with a cavity 151 at the inside thereof so as to be changed by an external force. The cavity 151 of the cushion protrusion 150 may be maintained at substantially atmospheric pressure. The cushion protrusion 150 may be restored to its original shape by elastic force when the external force applied to the cushion protrusion 150 is removed.

For example, the cavity 151 of the cushion protrusion 150 is not limited to atmospheric pressure. The cushion protrusion 150 may be coupled in a sealable state at the one surface 131 of the base plate 130. Accordingly, the cavity 151 of the cushion protrusion 150 may be maintained close to a vacuumed state. The cushion protrusion 150 may be formed with a thin film. When an external force is applied, a portion of the cushion protrusion 150 to which the external force is applied may be pressed toward the cavity 151, thereby increasing the internal pressure of the cavity 151 of the cushion protrusion 150. In this case, when the external force applied to the cushion protrusion 150 is removed, the cushion protrusion 150 may be restored to its original shape by the elastic force of the cushion protrusion 150 together with the pressure of the cavity 151. As described, the cushion protrusion 150 may be flexibly changed and restored like an inflated rubber balloon as air is supplied to the inside thereof.

According to one or more embodiments, the hook 170 may include a material having stiffness. For example, the hook 170 may include a stainless steel or a synthetic resin that has stiffness and is harmless to the human body.

According to one or more embodiments, the hook 170 may be integrally formed with the cushion protrusion 150 by being insert molded with the cushion protrusion 150. The hook 170 may include a first portion 171 that is positioned in the cavity 151 of the cushion protrusion 150, a second portion 172 that is extended from the first portion 171 and positioned outside of the cavity 151 of the cushion protrusion 150, and a bent portion 173 that becomes a boundary of the first portion 171 and the second portion 172. For example, the second portion 172 of the hook 170 may be bent at a determined angle with respect to the first portion 171. The first portion 171 of the hook 170 and the bent portion 173 of the second portion 172 may be connected at a portion of the cushion protrusion 150. The second portion 172 of the hook 170 may be disposed from a lower portion of the cushion protrusion 150 toward a lower end side of the first fingertip 100.

For example, the second portion 172 of the hook 170 may be disposed at a first distance from the one surface 131 of the base plate 130 as shown in FIG. 7. A first distance D1 may correspond to a distance from the one surface 131 of the base plate 130 to a maximally protruded portion of the cushion protrusion 150, that is, a thickness T of the cushion protrusion 150. As described, the second portion 172 of the hook 170 may be disposed to be maximally adjacent with the one surface 131 of the base plate 130. When the gripper 50 moves toward the food product 3 and reaches a position close to the food product 3, interference between the lower end 172a of the second portion 172 of the hook 170 and the food product 3 can be reduced or prevented. Accordingly, the gripper 50 may grasp the food product by smoothly moving the food product 3 to a pre-set point for grasping.

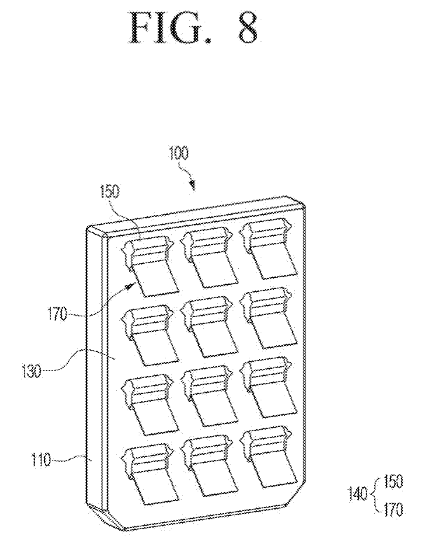

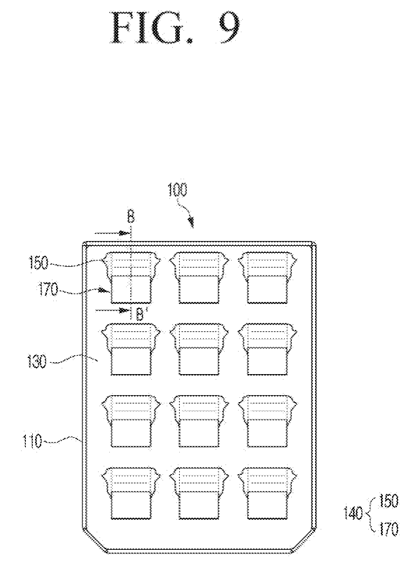

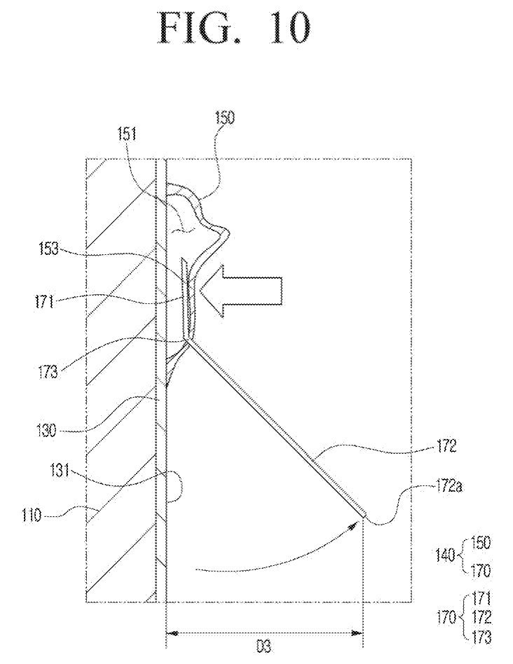

FIG. 8 is a perspective view illustrating the fingertip 100 of the gripper according to one or more embodiments of the disclosure. FIG. 9 is a front view illustrating the fingertip 100 of the gripper according to one or more embodiments of the disclosure. FIG. 10 is a cross-sectional view taken along line B-B’ shown in FIG. 9.

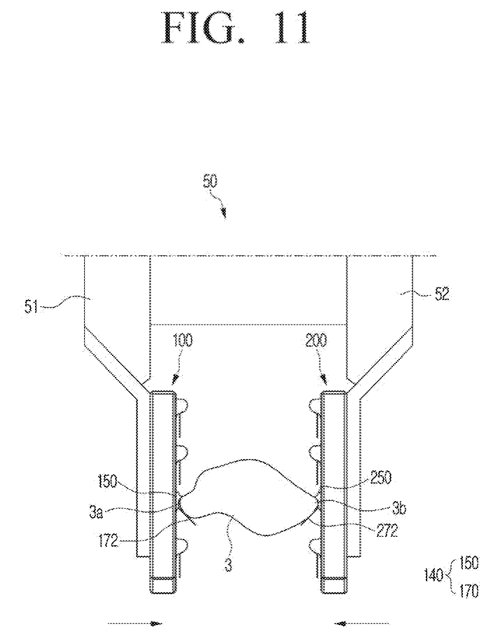

Referring to FIG. 8 and FIG. 9, the plurality of hook members 140 arranged in 4 rows × 3 columns at the first fingertip 100 may support a food product 3 for the food product 3 grasped between the first fingertip 100 and the second fingertip 200 to not drop in a gravitational direction. For example, when an external force is applied to a side of the base plate 130 toward the cushion protrusion 150 of each hook member 140, the cushion protrusion 150 may be changed as a portion thereof is pressed. In this case, the direction to which the external force is applied may be roughly a vertical direction of the base plate 130. Here, the external force acting at the cushion protrusion 150 may be a force pressing the cushion protrusion 150 by a portion 3a of the food product 3 (referring to FIG. 11) when the food product 3 is grasped between the first fingertip 100 and the second fingertip 200.

Referring to FIG. 10, as the cushion protrusion 150 is changed by the external force, the first portion 171 of the hook 170 positioned in the cavity 151 of the cushion protrusion 150 may also be applied with an external force. The first portion 171 of the hook 170 may be rotated in a direction adjacent to the one surface 131 of the base plate 130 based on the bent portion 173 of the hook 170. The second portion 172 of the hook 170 may be rotated in a direction that moves away from the one surface 131 of the base plate 130 based on the bent portion 173 by operating in association with the rotation of the first portion 171 of the hook 170. The bent portion 173 of the hook 170 may be a rotational center of the hook 170.

As described, the second portion 172 of the hook 170 may maintain an inclined state while the external force is being applied to the cushion protrusion 150 (or while the external force is being applied to the first portion 171 of the hook 170). In this case, the lower end 172a of the second portion 172 of the hook 170 may be protruded from the one surface 131 of the base plate 130 by a second distance D3 which is greater than the thickness D2 of the cushion protrusion (referring to FIG. 7).

FIG. 11 is a diagram illustrating an example of the gripper 50 grasping an irregular food product 3 according to one or more embodiments of the disclosure.

According to one or more embodiments, the robot apparatus 10 may perform an operation as described below to grasp the food product 3 contained in the side dish container 1.

According to one or more embodiments, the image sensor 30 (referring to FIG. 1) may capture an image of the food product 3 (e.g., side dish) (referring to FIG. 2) constituting a side dish contained in the side dish container 1 (referring to FIG. 2). The captured image may be stored in the memory 41 (referring to FIG. 1). The processor 43 (referring to FIG. 1) may identify the food product based on the obtained image. The processor 43 may control the image sensor 30 to obtain image information of a plurality of side dish pieces contained in the side dish container 1. For example, the image information may be image information including the position coordinates, sizes, shapes, and the like of each of the plurality of side dish pieces. Here, the position coordinates may be 3-dimensional coordinates corresponding to a center of each food product 3. The processor 43 may control for the image information obtained by the image sensor 30 to be stored in the memory 41. The processor 43 may obtain a position of the food product 3 which is subject to grasping (hereinafter, referred to as “target”) based on the image information.

For example, the processor 43 may obtain a distance from the first finger 100 and the second fingertip 200 disposed at an initial position to a surface of the target 3 based on the image information. The processor 43 may obtain a depth of the first fingertip 100 and the second fingertip 200 being moved to the target 3 based on the image information and characteristic information of the food product (e.g., the stiffness, density, texture, and the like of the material constituting the food product) stored in the memory 41. In this case, the processor 43 may control the driving motor 50a (referring to FIG. 1) to set a distance between the first fingertip 100 and the second fingertip 200 corresponding to the size of the target 3 based on the image information.

For example, the processor 43 may control the gripper 50 to move toward the target 3 by a determined distance to grasp the target 3 through the first fingertip 100 and the second fingertip 200. The first fingertip 100 and the second fingertip 200 may be disposed at a target grasping position, for example, a position corresponding to both sides of the target 3 (e.g., a left side 3a and right side 3b of the target 3).

Referring to FIG. 11, the processor 43 may control the driving motor 50a to forward rotate for the first fingertip 100 and the second fingertip 200 to move in a direction that becomes closer to each other. The first fingertip 100 and the second fingertip 200 may grasp a target 3 from among the food product stacked in the side dish container 1. In this case, the left side 3a of the target 3 may contact with the first fingertip 100, and the right side 3b of the target 3 may contact with the second fingertip 200.

For example, the left side 3a of the target 3 may contact at least one from among the plurality of hook members 140 of the first fingertip 100. In this case, the cushion protrusion 150 of the at least one hook member 140 may be pressed by the left side 3a of the target 3. The hook 170 of the at least one hook member 140 may support a lower portion of the target 3 by rotating in the anti-clockwise direction. The right side 3b of the target 3 may contact at least one from among the plurality of hook members 240 of the second fingertip 200. In this case, a cushion protrusion 250 of the at least one hook member 240 may be pressed by the right side 3b of the target 3. A hook 270 of the at least one hook member 240 may support the lower portion of the target 3 by rotating in the clockwise direction. In addition, when the target 3 which is a food product with an irregular and uneven surface (e.g., fried dumpling (fried mandu), squid fish cake bar (squid hot bar), fried shrimp, etc.) is grasped by the first and second fingertips 100 and 200, the hooks 170 and 270 of the plurality of hook members 140 and 240 protruded from the first and second fingertips 100 and 200 may increase a contact surface between the first and second fingertips 100 and 200 and the surface of the target 3. Accordingly, because friction force between the first and second fingertips 100 and 200 and the target 3 can be increased, the first and second fingertips 100 and 200 may stably grasp the target 3.

As described, while the left side 3a and the right side 3b of the target 3 is grasped by the first and second fingertips 100 and 200, the lower portion of the target 3 may be supported by the hook members 140 and 240 of the first and second fingertips 100 and 200. As described, the plurality of hook members 140 and 240 may improve on the food product 3 from being dropped from the first fingertip 100 and the second fingertip 200 due to factors that can lower a grasping success rate of the target 3 such as, for example, and without limitation, an angle by which the gripper 50 reaches into the side dish container 1 (referring to FIG. 2) in which the food product 3 (referring to FIG. 2) is stacked, an inaccurate target grasping point, mechanical and/or electrical vibrations of the robot apparatus 10, and the like.

For example, the processor 43 may control the robot arm 20 to move the gripper 50 to a determined position over the target container 9a (referring to FIG. 3). The gripper 50 may control the driving motor 50a to move the first finger 51 and the second finger 52 in a direction that moves away from each other to drop the target 3 in the target container 9a. The target 3 may be dropped in the target container 9a by its own weight as a grasping state by the first fingertip 100 and the second fingertip 200 is released. The hooks 170 and 270 of the plurality of hook members 140 and 240 of the first fingertip 100 and the second fingertip 200 may be rotated to their initial positions (referring to FIG. 7) as cushion protrusions 150 and 250 are restored to their original shapes.

The robot apparatus 10 according to one or more embodiments may transport another target 3 in the side dish container 1 to the target container 9b by repeatedly performing the process as described above.

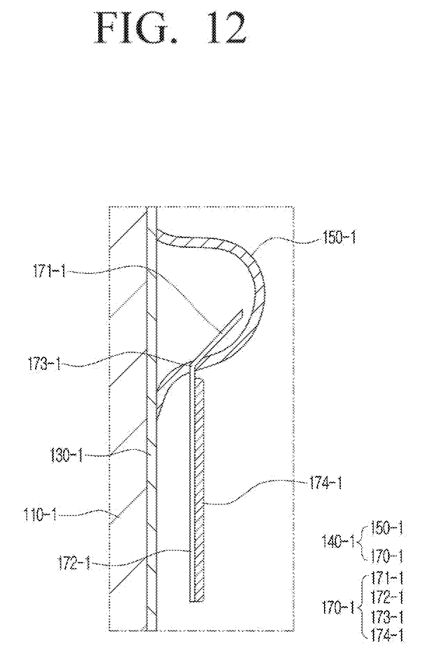

FIG. 12 is an enlarged cross-sectional view illustrating a hook member 140-1 according to one or more embodiments of the disclosure.

Referring to FIG. 12, the hook member 140-1 according to one or more embodiments may be substantially the same in most of the configuration as with the hook member 140 shown in FIG. 7. The hook member 140-1 may include a cushion protrusion 150-1 that is coupled to a base plate 130-1 which is coupled to a body 110-1 and a hook 170-1 that is coupled to the cushion protrusion 150-1 and is rotated in the anti-clockwise direction and clockwise direction when the cushion protrusion 150-1 is pressed and released from being pressed. The hook 170-1 may include a first portion 171-1 positioned in a cavity 151-1 of the cushion protrusion 150-1, a second portion 172-1 that is extended from the first portion 171-1 and positioned at an outer side of the cavity 151-1 of the cushion protrusion 150-1, and a bent portion 173-1 that becomes a boundary of the first portion 171-1 and the second portion 172-1 and becomes a rotational center of the hook 170-1.

According to one or more embodiments, the hook member 140-1 may include a coating layer 174-1 that is coupled to the second portion 172-1 of the hook 170-1 to which a food product 3 can be contacted so as to increase friction force with the food product 3 (referring to FIG. 11). For example, the coating layer 174-1 may include a material (e.g., silicon or rubber) having a greater friction coefficient than a friction coefficient of the hook 170-1.

For example, based on the hook 170-1 rotating when the food product 3 is grasped by the first and second fingertips (e.g., referring to 140 and 240 in FIG. 11), the coating layer 174-1 with a high friction coefficient may be contacted with the surface of the food product 3. Accordingly, food product dropping from between the first and second fingertips 100 and 200 may be minimized or improved.

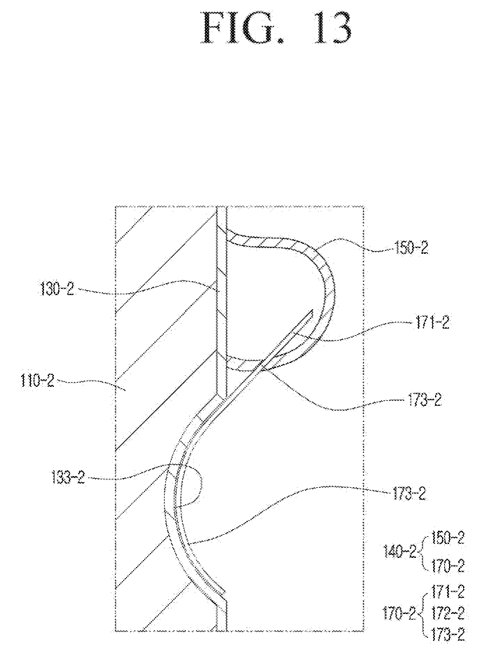

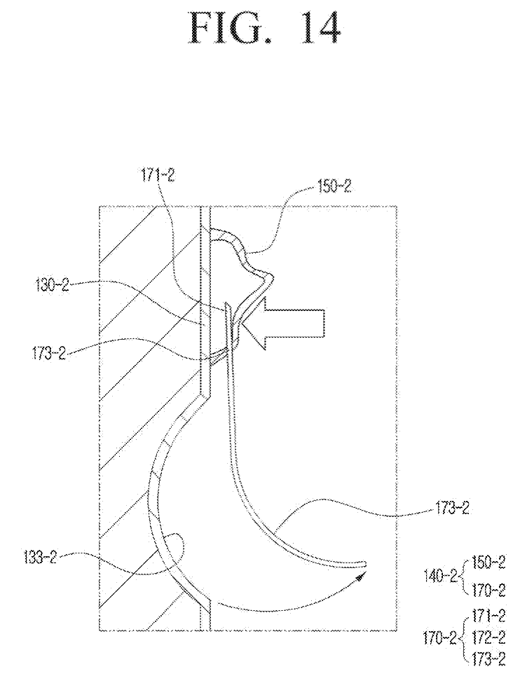

FIG. 13 is an enlarged cross-sectional view illustrating a hook member 140-2 according to one or more embodiments of the disclosure. FIG. 14 is an enlarged cross-sectional view illustrating an operating state of the hook member 140-2 shown in FIG. 13.

Referring to FIG. 13, the hook member 140-2 according to one or more embodiments may have the same configuration as the hook member 140 shown in FIG. 7, except for a hook 170-2 and a structure adjacent with the hook 170-2 (e.g., a portion of a body 110-2, a portion of a base plate 130-2).

According to one or more embodiments, the hook member 140-2 may include a cushion protrusion 150-2 that is coupled to the base plate 130-2 which is coupled to the body 110-2, and the hook 170-2 that is insert molded to the cushion protrusion 150-2 and is rotated in the anti-clockwise direction and clockwise direction when the cushion protrusion 150-2 is pressed and released from being pressed.

According to one or more embodiments, the hook 170-2 may include a first portion 171-2 positioned in a cavity 151-2 of the cushion protrusion 150-2, a second portion 172-2 that is extended from the first portion 171-2 and positioned at an outer side of the cavity 151-2 of the cushion protrusion 150-2, and a fixed portion 173-2 that is positioned between the first portion 171-2 and the second portion 172-2 and fixed at a cushion protrusion 150-2. For example, the fixed portion 173-2 of the hook 170-2 may become the rotational center that the hook 170-2 rotates when the cushion protrusion 150-2 is pressed and released from being pressed by an external force.

According to one or more embodiments, the second portion 172-2 of the hook 170-2 may have a determined curvature. For example, the second portion 172-2 of the hook 170-2 may be convexly formed toward the side of the body 110-2. In this case, the body 110-2 and the base plate 130-2 may be concavely formed respectively to have a predetermined curvature that corresponds to the second portion 172-2 of the hook 170-2. The second portion 172-2 of the hook 170-2 may be in a state inserted in a groove 133-2 which is formed at the base plate 130-2 before an external force is applied to the cushion protrusion 150-2.

For example, if the first and second fingertips (e.g., referring to 140 and 240 in FIG. 11) reaches into the side dish container 1 to grasp the targeted food product 3, the second portion 172-2 of the hook 170-2 may minimize or improve on the food product from being interfered. Accordingly, movement of the first and second fingertips 100 and 200 to the grasping position of the food product may be smoothly performed.

Referring to FIG. 14, if a food product 3 is grasped by the first and second fingertips 100 and 200, the cushion protrusion 150-2 that is contacted with the food product 3 may be changed as a portion of the cushion protrusion 150-2 is pressed according to being pressed by the food product 3. The hook 170-2 may be rotated about the fixed portion 173-2 of the hook 170-2 in the anti-clockwise direction according to the cushion protrusion 150-2 being pressed. In this case, the second portion 172-2 of the hook 170-2 may be protruded from the groove 133-2 of the base plate 130-2 toward the side of the food product 3. Because the second portion 172-2 of the hook 170-2 can more stably support the lower portion of the food product 3 due to having a curvature, the food product 3 grasped by the first and second fingertips 100 and 200 being dropped in the gravitational direction may be minimized or improved.

While one or more embodiments as described above have been illustrated and described in the limited embodiments and drawings, those of ordinary skill in the art may make various corrections and modifications from the description above. For example, an appropriate result may be achieved even if the described technologies are performed in different order from the described methods and/or elements such as the described system, structures, devices, and circuitry are coupled or combined in a different form from the methods described, or if replaced or substituted with another element or equivalents thereof. Accordingly, it is to be understood that other implementations, embodiments, and those equivalent with the claimed scope fall within the claimed scope described below.

What is claimed is:

1. A gripper comprising:
a first finger;
a second finger facing the first finger;
a driving motor configured to provide power to drive the first finger and the second finger closer to each other and to drive the first finger and the second finger away from each other;
a first fingertip connected to the first finger; and
a second fingertip connected to the second finger and facing the first fingertip,
wherein each of the first fingertip and the second fingertip comprises:
a body;
a base plate coupled to the body; and
a hook member on the base plate, and
wherein the hook member is configured to protrude when pressed by an object while the first fingertip and the second fingertip grasp the object.

2. The gripper of claim 1, wherein for each of the first fingertip and the second fingertip, the hook member comprises:
a cushion protrusion coupled to one surface of the base plate, the cushion protrusion comprising a cavity; and
a hook connected to the cushion protrusion, wherein the hook is configured to rotate in a first direction when a pressing force is applied to the cushion protrusion and rotate in a second direction which is opposite of the first direction when a pressing force is released from the cushion protrusion.

3. The gripper of claim 2, wherein for each of the first fingertip and the second fingertip, the hook comprises:
a first portion positioned at the cavity of the cushion protrusion;
a second portion connected to the first portion, wherein the second portion is outside of the cushion protrusion and is bent at an angle with respect to the first portion; and
a third portion positioned at a boundary of the first portion and the second portion, wherein the third portion is connected to the cushion protrusion, and
wherein, for each of the first fingertip and the second fingertip, the hook is configured to rotate in the first direction or the second direction using the third portion as a rotational center.

4. The gripper of claim 3, wherein for each of the first fingertip and the second fingertip:
the first portion is configured to move toward the base plate based on application of a pressing force to the cushion protrusion, and
the second portion is configured to move away from the base plate and support an object grasped by the first fingertip and the second fingertip based on rotation of the first portion.

5. The gripper of claim 3, wherein for each of the first fingertip and the second fingertip, the second portion is configured to be moved to a first position at which a lower end of the second portion and the base plate are spaced apart by a first distance, and to be moved to a second position at which the lower end of the second portion and the base plate are spaced apart by a second distance that is greater than the first distance.

6. The gripper of claim 5, wherein for each of the first fingertip and the second fingertip, the second portion is parallel to the base plate at the first position.

7. The gripper of claim 6, wherein the first distance is smaller than a thickness of the cushion protrusion.

8. The gripper of claim 3, wherein for each of the first fingertip and the second fingertip, the second portion of the hook is concavely formed toward the base plate and is configured to be inserted in a groove on the base plate.

9. The gripper of claim 2, wherein for each of the first fingertip and the second fingertip, the cushion protrusion comprises silicon or rubber.

10. The gripper of claim 2, wherein for each of the first fingertip and the second fingertip, the hook comprises stainless steel or synthetic resin.

11. The gripper of claim 3, wherein for each of the first fingertip and the second fingertip, the second portion comprises a coating layer having a friction coefficient greater than a friction coefficient of the hook at a side surface that is contacted with the object.

12. The gripper of claim 1, wherein the first fingertip is connected to the first finger through a first supporter, and
wherein the second fingertip is connected to the second finger through a second supporter.

13. The gripper of claim 12, wherein the first fingertip is elastically connected to the first supporter, and
wherein the second fingertip is elastically connected to the second supporter.

14. The gripper of claim 12, wherein the first finger and the second finger further comprise a magnetic material,
wherein the first fingertip comprises a first permanent magnet,
wherein the first permanent magnet detachably attaches the first fingertip to the first finger,
wherein the second fingertip comprises a second permanent magnet, and
wherein the second permanent magnet detachably attaches the second fingertip to the second finger.

15. A robot apparatus comprising:
a robot arm comprising a plurality of joints;
a gripper connected to an end portion of the robot arm, the gripper comprising a first finger coupled with a first fingertip and a second finger coupled with a second fingertip;
a driving motor configured to provide power to the gripper to move the first finger and the second finger away from each other and closer to each other;
an image sensor configured to obtain an image of a target contained in a container;
memory storing at least one instruction; and
at least one processor configured to individually or collectively execute the at least one instruction,
wherein the at least one instruction, when executed by the at least one processor individually or collectively, causes the robot apparatus to:
identify the target based on the image, and
control the driving motor to move the first finger and the second finger together to grasp the target through the first fingertip and the second fingertip,
wherein each of the first fingertip and the second fingertip comprises:
a body;
a base plate coupled to the body; and
a hook member on the base plate,
wherein the hook member is configured to protrude when pressed by the target while the first fingertip and the second fingertip grasp the target, and
wherein for each of the first fingertip and the second fingertip, the hook member comprises:
a cushion protrusion coupled to one surface of the base plate, the cushion protrusion comprising a cavity; and
a hook connected to the cushion protrusion, wherein the hook is configured to rotate in a first direction when a pressing force is applied to the cushion protrusion and rotate in a second direction which is opposite of the first direction when a pressing force is released from the cushion protrusion.

16. The robot apparatus of claim 15, wherein for each of the first fingertip and the second fingertip, the hook comprises:
a first portion positioned at the cavity of the cushion protrusion;
a second portion connected to the first portion, wherein the second portion is outside of the cushion protrusion and is bent at an angle with respect to the first portion; and
a third portion positioned at a boundary of the first portion and the second portion, wherein the third portion is connected to the cushion protrusion, and
wherein, for each of the first fingertip and the second fingertip, the hook is configured to rotate in the first direction or the second direction using the third portion as a rotational center.

17. The robot apparatus of claim 16, wherein for each of the first fingertip and the second fingertip:
the first portion is configured to move toward the base plate based on application of a pressing force to the cushion protrusion, and
the second portion is configured to move away from the base plate and support an object grasped by the first fingertip and the second fingertip based on rotation of the first portion.

18. The gripper of claim 16, wherein for each of the first fingertip and the second fingertip, the second portion is configured to be moved to a first position at which a lower end of the second portion and the base plate are spaced apart by a first distance, and to be moved to a second position at which the lower end of the second portion and the base plate are spaced apart by a second distance that is greater than the first distance.

19. A gripper comprising:
a first finger;
a second finger facing the first finger;
a driving motor configured to provide power to drive the first finger and the second finger closer to each other and to drive the first finger and the second finger away from each other;
a first fingertip connected to the first finger; and
a second fingertip connected to the second finger and facing the first fingertip,
wherein the first fingertip comprises:
a body;
a base plate coupled to the body; and
a plurality of hook members on the base plate, and
wherein each of the plurality of hook members is configured to protrude when pressed by an object while the first fingertip and the second fingertip come into contact with the object.

20. The gripper of claim 19, wherein each of the plurality of hook members comprises:
a cushion protrusion coupled to one surface of the base plate, the cushion protrusion comprising a cavity; and
a hook connected to the cushion protrusion, wherein the hook is configured to rotate in a first direction when pressing force is applied to the cushion protrusion and rotate in a second direction which is opposite of the first direction when pressing force is released from the cushion protrusion.
